(19) United States
(12) Patent Application Publication
(10) Pub. No.: US 2018/0095906 A1
(43) Pub. Date: Apr. 5, 2018

(54) HARDWARE-BASED SHARED DATA COHERENCY

(71) Applicant: Intel Corporation, Santa Clara, CA (US)

(72) Inventors: Kshitij A. Doshi, Tempe, AZ (US); Francesc Guim Bernat, Barcelona (ES); Daniel Rivas Barragan, Cologne (DE)

(73) Assignee: Intel Corporation, Santa Clara, CA (US)

(21) Appl. No.: 15/283,284

(22) Filed: Sep. 30, 2016

(51) Int. Cl. G06F 13/16; G06F 3/06; G06F 12/1027; G06F 13/18; G06F 12/14

(52) U.S. Cl. CPC G06F 13/1663; G06F 3/0619; G06F 3/0659; G06F 3/067; G06F 2212/68; G06F 13/18; G06F 12/1433; G06F 2212/1052; G06F 12/1027

(57) ABSTRACT

Apparatuses, systems, and methods for coherently sharing data across a multi-node network is described. A coherency protocol for such data sharing can include identifying a memory access request from a requesting node for an I/O block of data in a shared I/O address space of a multi-node network, determining a logical ID and a logical offset of the I/O block, identifying an owner of the I/O block, negotiating permissions with the owner of the I/O block, and performing the memory access request on the I/O block.

### BACKGROUND

Data centers and other multi-node networks are facilities that house a plurality of interconnected computing nodes. For example, a typical data center can include hundreds or thousands of computing nodes, each of which can include processing capabilities to perform computing and memory for data storage. Data centers can include network switches and/or routers to enable communication between different computing nodes in the network. Data centers can employ redundant or backup power supplies, redundant data communications connections, environmental controls (e.g., air conditioning, fire suppression) and various security devices. Data centers can employ various types of memory, such as volatile memory or non-volatile memory.

### BRIEF DESCRIPTION OF THE DRAWINGS

FIG. 1 illustrates a multi-node network in accordance with an example embodiment;

FIG. 2 illustrates data sharing between two nodes in a traditional multi-node network;

FIG. 3 illustrates a computing node from a multi-node network in accordance with an example embodiment;

FIG. 4 illustrates memory mapped access and direct storage access flows for determining a logical object ID and a logical block offset for an I/O block in accordance with an example embodiment;

FIG. 5 illustrates communication between two computing nodes of a multi-node system in accordance with an example embodiment;

FIG. 6 is a diagram of a process flow between computing nodes in accordance with an example embodiment;

FIG. 7 is a diagram of a process flow between computing nodes in accordance with an example embodiment;

FIG. 8 is a diagram of a process flow between computing nodes in accordance with an example embodiment;

FIG. 9 is a diagram of a process flow within a computing node in accordance with an example embodiment;

FIG. 10 is a diagram of a process flow between computing nodes in accordance with an example embodiment;

FIG. 11 is a diagram of a process flow between computing nodes in accordance with an example embodiment; and

FIG. 12 shows a diagram of a method of sharing data while maintaining data coherence across a multi-node network in accordance with an example embodiment.

### DESCRIPTION OF EMBODIMENTS

Although the following detailed description contains many specifics for the purpose of illustration, a person of ordinary skill in the art will appreciate that many variations and alterations to the following details can be made and are considered included herein.

Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall concepts articulated herein, but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

### Example Embodiments

An initial overview of embodiments is provided below and specific embodiments are then described in further detail. This initial summary is intended to aid readers in understanding the disclosure more quickly, but is not intended to identify key or essential technological features, nor is it intended to limit the scope of the claimed subject matter.

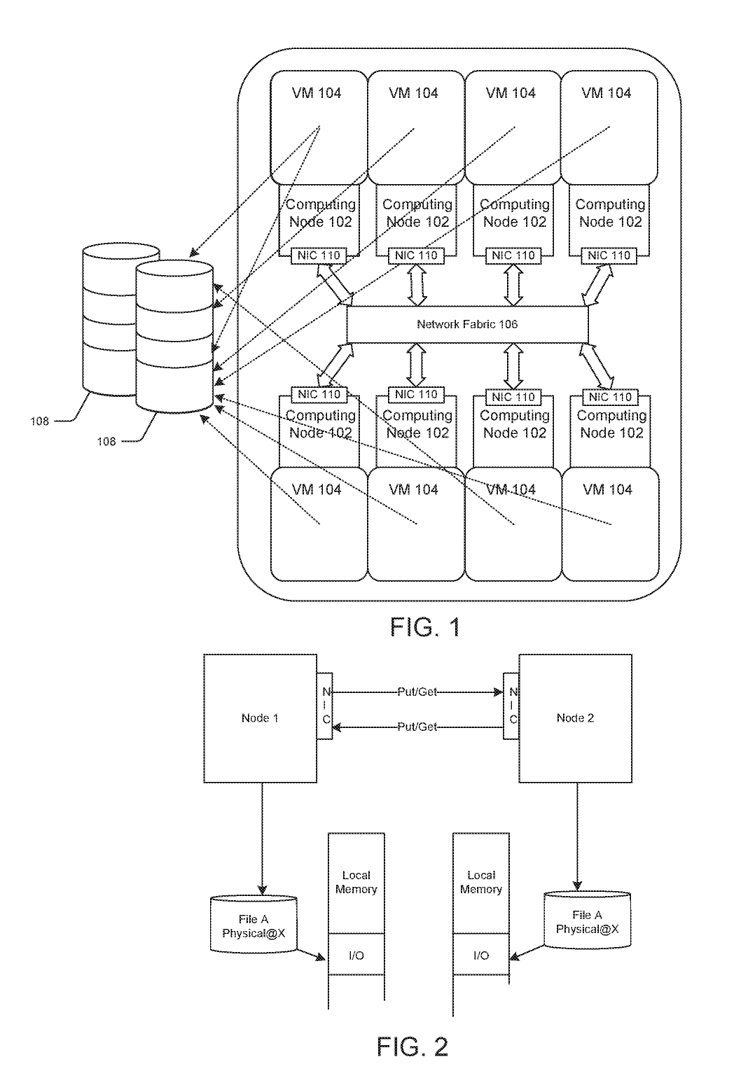

The presently disclosed technology relates maintaining the coherence of data shared across a multi-node network. FIG. 1 illustrates an example of a scale out-type architecture network of computing nodes 102, with each computing node 102 having a virtual memory (VM) address space 104. The computing nodes each include a network interface controller (NIC), and are communicatively coupled together via a network or switch fabric 106 through the NICs. Each node additionally has the capability of executing various processes. FIG. 1 also shows shared storage objects 108 (i.e. I/O blocks), which can be accessed by nodes either through explicit input/output (I/O) calls (such as file system calls, object grid accesses, block I/Os from databases, etc) or implicitly by virtue of fault handling and paging. Networks of computing nodes can be utilized in a number of processing/networking environments, and any such utilization is considered to be within the present scope. Non-limiting examples can include within data centers, including non-uniform memory access (NUMA) data centers, in between data centers, in public or private cloud-based networks, high performance networks (e.g. Intel's STL, InfiniBand, 10 Gigabit Ethernet, etc.), high bandwidth-interconnect networks, and the like.

One challenge that has been problematic in many traditional networking environments is data coherence, or, in other words, maintaining shared data consistently and coherently in a networking environment where multiple computing nodes can be accessing shared memory simultaneously. Even as they occur over a high performance (i.e. low latency, high bandwidth) communication fabric, it can be challenging to complete shared memory operations predictably and consistently within the stringent latency bounds for real-time (or quasi-real-time) operations. A process that runs within a single node and confines its accesses to local I/O objects can often meet stringent latency demands, even when there is a high miss rate in its page cache, by, for example, employing high performance non-volatile memory express (NVMe)-based solid state drives (SSDs). Between nodes, a similar capability is possible. Through a combination of high speed fabric, NVM caches (or buffers), and NVMe-based SSDs, processes can perform I/O transfers quickly. In some cases, small objects can even be transferred quickly over remote direct memory access (RDMA) links. However, bounding latencies on remote I/O objects can be difficult, because consistency needs to be maintained between readers and writers of the I/O objects.

FIG. 2 shows one example of how coherency issues can arise in traditional systems, where Node 2 is accessing and using File A, owned by Node 1. In traditional software-based coherence systems, software at Node 2 coordinates the sharing of memory with Node 1. FIG. 2 shows Put/Get primitives between nodes using remote direct memory access (RDMA). Once Node 2 obtains File A, multiple copies are present in the I/O memory (i.e. virtual memory) of the system. If either node modifies their associated copy, then multiple inconsistent copies of File A can be present, unless software explicitly performs broadcast invalidations, tracks ownership, caching, or uses acquire/release consistency semantics. Such software operations add considerable system and central processing unit (CPU) overhead, and are vulnerable to network partition problems as a result of machine or fabric failures.

The presently disclosed technology addresses the aforementioned coherence issues relating to data sharing across a multi-node network, by maintaining shared data coherence at the hardware-level, as opposed to traditional software solutions, where software needs to track which nodes have which disk blocks and in what state. Such a hardware-based coherence mechanism can be implemented at the network interfaces (e.g. network interface controllers) of computing nodes that are coupled across a network fabric, switch fabric, or other communication or computation architecture incorporating multiple computing nodes. In some examples, a protocol similar to MESI (Modified, Exclusive, Shared, Invalid) can be used to track a coherence state of a given I/O block; however, the presently disclosed coherence protocol differs from a traditional MESI protocol in that it is implemented across interconnected computing nodes utilizing block-grained permission state tracking. Thus, the presently disclosed technology is focused on the consistency of shared storage objects (or I/O blocks) as opposed to memory ranges directly addressed by CPUs. It is noted that the terms “I/O block” and “shared storage object” can be used interchangeably, and refer to chunks of the shared I/O address space that are, in one example, the size of the minimum division of that address space, similar to cache lines in a cache or memory pages in a memory management unit (MMU). In one example, the size of the I/O block can be a power of two in order to simplify the coherence logic. The I/O blocks can vary in size across various implementations, and in some cases can depend on usage. For example, the I/O block is fixed for a given system run, or in other words, from the time the system boots until a subsequent reboot or power loss. Thus, the I/O block can be changed when the system boots, similar to setting a default page size in traditional computing systems. In other examples, the block size could be varied per application in order to track I/O objects, although such a per application scheme would add considerable overhead in terms of complexity and latency.

With hardware support for tracking and maintaining shared data coherence at the I/O block-level (i.e., I/O block grained coherence), the present coherence protocol allows a process to work with chunks (pages, blocks, etc.) of items on memory storage devices anywhere in a scale out-type cluster, as if they are local, by copying them to the local node and letting the hardware automate virtually all of the coherency interactions. While various other traditional coherency solutions may also make local copies of remote I/O objects and operate on them, software (either a client process or a file system layer) is required to track and manage all of the consistency issues. Managing consistency in software creates CPU overhead, unpredictable latencies, and significant difficulties with scaling while maintaining stringent latency quality-of-service (QoS).

A hardware-based coherency system, however, can function seamlessly and transparently compared to software solutions, therefore reducing CPU overhead, improving the predictability of latencies, and reducing or eliminating many scaling issues. Various configurable elements (e.g. snoop filter, local cache, etc.) can be tuned in order to adjust desired scalability or performance.

In one general example, the coherency protocol can be implemented in circuitry that is configured to identify that a given memory access request from one of the computing nodes (the requesting node in this case) is to an I/O block that resides in the shared I/O address space of a multi-node network. The logical ID and logical offset of the I/O block are determined, from which the identity of the owner of the I/O block is identified. The requesting node then negotiates I/O permissions with the owner of the I/O block, after which the memory access proceeds. The owner of the I/O block can be a home node, a sharing node, the requesting node, or any other possible I/O block-to-node relationship.

More specifically, each computing node can include one or more processors (e.g., CPUs) or processor cores and memory. A processor in a first node can access local memory (i.e., first computing node memory) and, in addition, the processor can negotiate to access shared I/O memory owned by other computing nodes through an interconnect link between computing nodes, nonlimiting examples of which can include, switched fabrics, computing and high performance computing fabrics, network or Ethernet fabrics, and the like. The network fabric is a network topology that communicatively couples the computing nodes of the system together. In a multi-node network, applications can perform various operations on data residing locally and in the shared I/O space, provided the operations are within the confines of the coherency protocol. In addition, the applications can execute instructions to move or copy data between the computing nodes. As a non-limiting example, an application can negotiate coherence permissions and move shared I/O data from one computing node to another. As another non-limiting example, a computing node can create copies of data that are moved to local memory in different nodes for read access purposes.

In one example, each computing node can include a memory with volatile memory, non-volatile memory, or a combination thereof. Volatile memory is a storage medium that requires power to maintain the state of data stored by the medium. Exemplary memory can include any combination of random access memory (RAM), such as static random access memory (SRAM), dynamic random access memory (DRAM), synchronous dynamic random access memory (SDRAM), and the like. In some examples, DRAM complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org.).

Non-volatile memory is a storage medium that does not require power to maintain the state of data stored by the medium. Nonlimiting examples of nonvolatile memory can include any or a combination of: solid state memory (such as planar or 3D NAND flash memory, NOR flash memory, or the like), including solid state drives (SSD), cross point array memory, including 3D cross point memory, phase change memory (PCM), such as chalcogenide PCM, non-volatile dual in-line memory module (NVDIMM), a network attached storage, byte addressable nonvolatile memory, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, spin transfer torque (STT) memory, nanowire memory, electrically erasable programmable read-only memory (EEPROM), magnetic storage memory, hard disk drive (HDD) memory, a redundant array of independent disks (RAID) volume, write in place non-volatile MRAM (NVMRAM), and the like. In some examples, non-volatile memory can comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

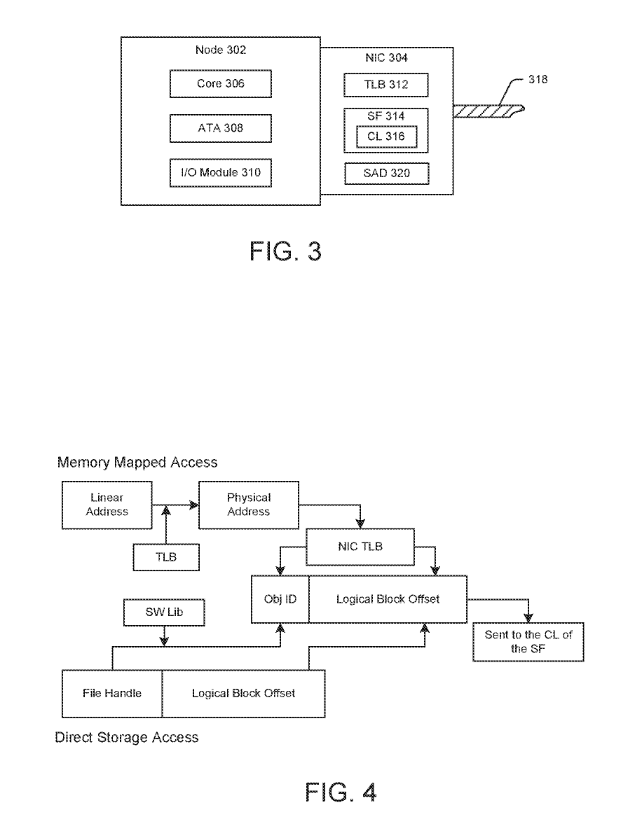

In order to implement a coherency protocol throughout a multi-node network along shared I/O address space, various modifications to traditional architecture can be beneficial. FIG. 3 illustrates an example computing node 302 with an associated NIC 304 from a multi-node network. The computing node 302 can include at least one processor or processing core 306, an address translation agent (ATA) 308, and an I/O module 310. The NIC 304 is interfaced with the computing node 302, and can be utilized to track and maintain shared memory consistency across the computing nodes in the network. The NIC can also be referred to as a network interface controller. Each NIC 304 can include a translation lookaside buffer (TLB) 312, and a snoop filter 314 with a coherency logic (CL) 316. The NIC additionally can include a system address decoder (SAD) 320. The NIC 304 is coupled to a network fabric 318 that is communicatively interconnected between the NICs of the other computing nodes in the multi-node network. As such, the NIC 304 of the computing node 302 communicates with the NICs of other computing nodes in the multi-node network across the network fabric 318.

The ATA 308 is a computing node component configured to identify that an address associated with a memory access request, from the core 306, for example, is in the shared I/O space. If the address is in the shared I/O space, then the ATA 308 forwards the memory access request to the NIC 304, which in turn negotiates coherency permission states (or coherency states) with other computing nodes in the network, via the snoop filter (SF). In some examples, the ATA 308 can include the functionality or a caching agent, a home agent, or both.

As has been described, a MESI-type protocol is one useful example of a coherence protocol for tracking and maintaining coherence states of shared data blocks. In such a protocol, each I/O block is marked with one of four coherence states, modified (M), exclusive (E), shared (S), or invalid (I). In a modified state, the I/O block has been modified compared to the I/O block in the shared I/O memory, or in other words, the I/O block is “dirty.” The modified coherence state signifies that the I/O block is invalid, and needs to be written back into the shared I/O memory before any other node is allowed access. The exclusive coherence state signifies that the I/O block is accessible only by a single node. In this case the I/O block at the node having “exclusive” coherence permission matches the I/O block in the shared memory state, and is thus is a “clean” I/O block, or in other words, is up to date and does not need to be written back to shared memory. Upon receiving a read access request, the coherence state can be changed to shared. If the I/O block is modified by the node, then the coherence state is changed to “modified,” and needs to be written to shared I/O memory prior to access by another node in order to maintain shared I/O data coherence. The “shared” coherence state signifies that copies of the I/O block may be stored at other nodes, and that the I/O block is currently in an unmodified state. The invalid coherence state signifies that the I/O block is not valid, and is unused.

In one non-limiting example of coherence protocol operation, a read access request can be fulfilled for an I/O block in any coherence state except invalid or modified (which is also invalid). A write access can be performed if the I/O block is in a modified or exclusive state, which maintains coherence by limiting write access to a single node. For a write access to an I/O block in a shared state, all other copies of the I/O block need to be invalidated prior to writing. One technique for performing such invalidations is by an operation referred to as a Read For Ownership (RFO), described in more detail below. A node can discard an I/O block in the shared or exclusive state, and thus change the coherence state to invalid. In the case of a modified state, the I/O block needs to be written to the shared I/O space prior to invalidating the I/O block.

In one example implementation of local tracking of coherence states, the SF 314 and the associated CL 316 are configured to track the coherence state of each I/O block category according to the following:

I/O blocks owned by a local process: For each of these I/O blocks, the computing node 302 is their home node, and the SF 314 (along with the CL 316) thus maintains updated coherence state information, sharing node identifiers (IDs), and virtual addresses of the I/O blocks. For example, when a node requests read access for a shared block, the home node updates the list of sharers in the SF to include the requesting node as a sharer of the I/O block. When a node requests exclusive access, the home node snoops to invalidate all sharers in the list (except the requesting node) and updates its snoop filter entry.

I/O Blocks in a valid state, but not owned by a local process: For each of these I/O blocks, the SF maintains the coherence state, home node ID, and the virtual address. In one example, the SF does not maintain the coherence state of sharing-node blocks, which are taken care of by the home nodes of each I/O block. In other words, I/O block information stored by a node is different, depending on whether the node is the owner or just a user (or requestor) of the I/O block. For example, the I/O block owner maintains a list of all sharing nodes in order to snoop such nodes. A user node, on the other hand, maintains the identity of the owner node in order negotiate memory access permissions, along with the coherence state of the I/O block. Thus, the local SF includes an entry for each I/O block for which the local NIC has coherence state permission and is not the home node. This differs from traditional implementations of the MESI protocol using distributed caches, where each SF tracks only lines of their own cache, and any access to a different cache line needs to be granted by that line's cache SF. Under the present protocol, if a non-home node has a SF entry for a requested block that is valid, the node can proceed with the requested access (assuming it is consistent with the coherence state) without having to communicate through the fabric to negotiate permissions, thus saving considerable overhead. In one alternative example, each node could maintain coherence states for all I/O blocks in the shared address space, or in another alternative example all coherence tracking and negotiation could be processed by a central SF. In each of these examples, however, communication and latency overhead would be significantly increased.

Portions of the address space owned by other nodes: Each node that is exposing a portion of the shared address space will have an entry in the SF. As such, for each access to an I/O block that is not owned by local processes and that is not in a valid state, the SF knows where to forward the request, because the SF has the current status and home node for the I/O block.

In some examples, the SF includes a cache, and it can be beneficial to for such cache to be implemented with some form of programmable volatile or non-volatile memory. One reason for using such memory is to allow the cache to be configured during the booting process of the system, device, or network. Additionally, multi-node systems can be varied upon booting. For example, the number of computing nodes and processes can be varied, the memory storage can be increased or decreased, the shared I/O space can be configured to specify, for example, the size of the address space, and the like. As such, the number of entries in a SF can vary as the I/O block size and/or address space size are configured.

Regarding addressing, computing nodes using the shared I/O space communicate with one another using virtual addresses, while a local ATA uses physical addresses. As such, when the ATA of a computing node forwards a memory access request to the NIC, the TLB in the NIC translates or maps the physical address to an associated virtual address. On the other hand, if a memory access request comes from the network fabric, the SF will be using the virtual address. If the memory access request with the virtual address triggers a local memory access, the TLB will translate the virtual address to a physical address in order to allow access to the local node.

Accordingly, the coherency protocol for a multi-node system can handle shared data consistency for both mapped memory access and direct memory access modes. Mapped memory access is more complicated due to reverse indexing, or in other words, mapping from a physical address coming out of a node's cache hierarchy back to a logical 110 range. Whether reverse translated from a mapped memory access or taken directly from a direct memory access, such as a read/write call from a software process or direct memory access from another node, a logical (i.e. virtual) ID and a logical block offset (or size) of an IO block is made available to the NIC. FIG. 4, for example, shows a diagram for both memory mapped access and direct storage access modes. In memory mapped access situations, for example, an address from a core of a computing node is sent to the ATA, which is translated by the ATA TLB into the associated physical address. Upon identifying that the data at the physical address is in the shared I/O space, the ATA sends the physical address to the NIC-TLB, which translates the physical address to a shared I/O (i.e., logical, virtual) address having a logical object ID and a logical block offset. The memory access with the associated shared I/O address is sent to the SF for performing a check against a distributed SF/inquiry mechanism. In direct storage access situations, such as direct read or write calls, for example, the memory access request is using the shared I/O address, and as such, the logical object ID and the logical block offset can be used directly by the NIC without using the TLB for address translation. The memory access with the associated shared I/O address is sent to the SF for performing a check against the distributed SF/inquiry mechanism.

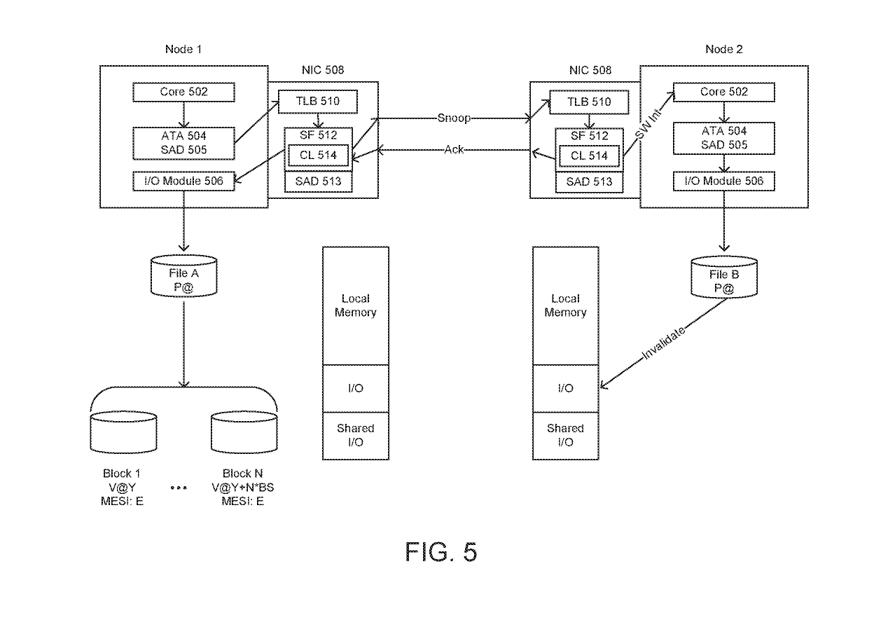

Various snoop inquiries can be home node-based in some examples, or early multicast-based amongst NICs in other examples. A multicast snoop inquiry, as used herein, refers to a snoop inquiry that is broadcast from a requesting node directly to multiple other nodes, without involving the home node (although the multicast can snoop the home node). Additionally, a similar broadcast is further contemplated where a snoop inquiry can be broadcast from a requesting node directly to another node without involving the home node. For the multicast case, in one example the NIC of the requesting node can transparently perform the shared I/O coherence inquiry for memory access, and can optionally initiate a prefetch for a read access request (or for a non-overlapping write access request) from a nearby available node. If shared I/O negotiations are not needed, the requesting node's NIC updates its local SF state, and propagates the state change across the network.
FIG. 5 shows one nonlimiting example of a network having two computing nodes, Node 1 and Node 2. Each node includes at least one processor or processor core 502, an address translation agent (ATA) 504, an I/O module 506, and a network interface controller (NIC) 508. In operation, the core 502 sends memory access requests to the ATA 504. If the ATA 504 determines that the core is accessing shared I/O space, then the memory access request is sent to the NIC 508. In one example, the ATA 504 includes a system address decoder (SAD) 505 that maintains the shared address space exposed by the local and all other nodes. The SAD 505 receives the physical address from the ATA 504, and determines whether the physical address is part of the shared I/O space. Thus, in some examples, system memory controllers can be modified to place mapped pages in a range of physical memory (whether volatile or persistent) that allows a node's ATA SAD to determine when to forward a coherence state inquiry to the NIC.

Each NIC 508 in each computing node includes a translation lookaside buffer (TLB, or NIC TLB) 510 and a snoop filter (SF) 512 over the shared I/O block identifiers (logical IDs) owned by the node. Each SF 512 includes a coherency logic (CL) 514 to implement the coherency flows (snooping, write backs, etc.). The NIC can further include a SAD 513 to track, among other things, the home nodes associated with each portion of the shared I/O space. Upon receiving a memory access request at the NIC 508 from the ATA 504 (or SAD 505), the physical address is translated to the logical address by the TLB 510 translates the physical address associated with the memory access request to a shared I/O address associated with the shared I/O space. The memory access request is sent to the SF 512, which checks the coherency logic, the results of which may elicit various snoop inquiries, depending on the nature of the memory access request and the location of the associated I/O blocks.

As one example, assume that the SF 512, CL 514, and SAD 513 of Node 1 determine that the coherence state of the I/O block is set to shared, that Node 1 is trying to write, and that Node 2 is the home node for the I/O block. Node 1's NIC then sends a snoop inquiry to Node 2 to invalidate the shared I/O block. Node 2 receives the snoop inquiry and its SF 512 and proceeds to invalidate the shared I/O block locally. If software/processes at Node 2 have mapped the shared I/O block into local memory, then the NIC of Node 2 invalidates the mapping by interrupting any software processes utilizing the mapping, which may cause the software to perform a recovery. This situation should be rare in the presence of upper level consistency protocols, but acts as a safety net in rare cases (including outages). Node 2 sends an acknowledgment (Ack) to Node 1, the requested shared I/O block is sent to Node 1, and/or the access permissions are updated at Node 1. Node 1 now has exclusive (E) rights to access I/O block 1 to 110 block n in the shared I/O space. Had the memory access originated as a direct 10 access at Node 1 (as shown at the bottom left of FIG. 4), then the translation step at the TLB would been replaced by a mapping to the shared 110 address at Node 1.

In the rare event that an outage creates a transient state conflict (i.e., one node thinks the object is in S state but it is in an E/M state somewhere), a resolution is afforded by elevation to the software. In one example, the home node grants S/E status to a new owner if the current owner has stopped responding with a specific timeout window. Further details are outlined below.

As has been described, the shared I/O space can be carved out at an I/O block granularity. The size of this space is determined through common boot time settings for the machines in a cluster. In one example, IO blocks can be sized in blocks or power-of-two multiples of blocks, with a number of common sizes to meet most needs efficiently. The total size can range into the billions of entries, and the coherency state bits needed to track these entries would be obtained from, for example, non-volatile memory.

A system and its processes coordinate (transparently through the kernel or via a library) the maintaining of the shared I/O address space. At boot time, the NIC and the ATA maps have to be either allocated or initialized. As processes (using kernel capabilities, for example) map I/O blocks into their memory, and the necessary entries are initialized in the NIC-based translation mechanism. For partitioned global address space (PGAS) organizations, NICs also send common address maps for IO blocks so that the same range address is translated consistently to the same IO blocks across all nodes implementing the PGAS. It is noted that a system can utilize multiple coherence mechanisms, such as PGAS along with the present coherence protocol, provided the NIC is a point of consistency between the various mechanisms.

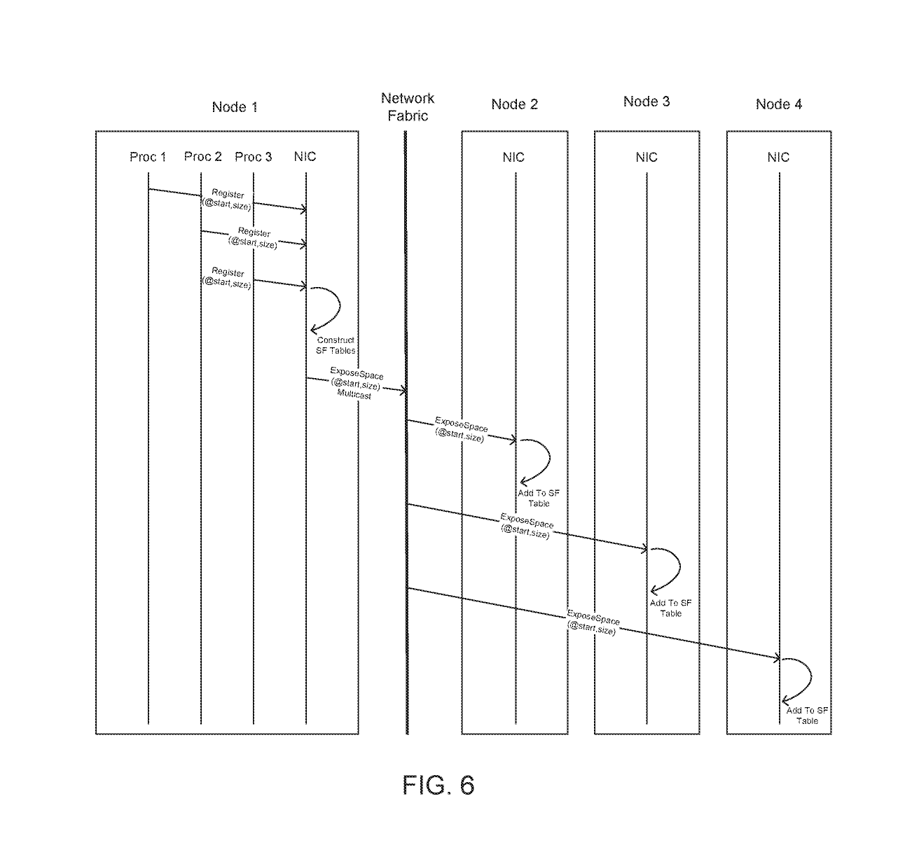

FIG. 6 shows one non-limiting example flow of the registration and exposure of shared address space by a node. Specifically, an example collection of processes 1, 2, and 3 (Proc 1-3) of Node 1 (the registering node) initiate the registration of shared address space and its exposure to the rest of the nodes in the system. Process 1, 2, and 3 each send a message to the NIC of Node 1 to register a portion of the shared address space, in this case referencing a start location of the address and an address size (or offset). Register(@start,size) in FIG. 6 thus refers to the message to register the shared address space starting at “start,” and having an address offset of “size”. In response, NIC constructs the tables of the SF, waits until all process information has been received, and then sends a multicast message to Nodes 2, 3 and 4 (sharing nodes) through the switch to expose the portion of the shared address space on Node 1. Nodes 2, 3 and 4 add an entry to their SF's tables in order to register Node 1's shared address space. ExposeSpace(@start, size) in FIG. 6 thus refers to the message to register the shared address space starting at “start,” and having an address offset of “size”.

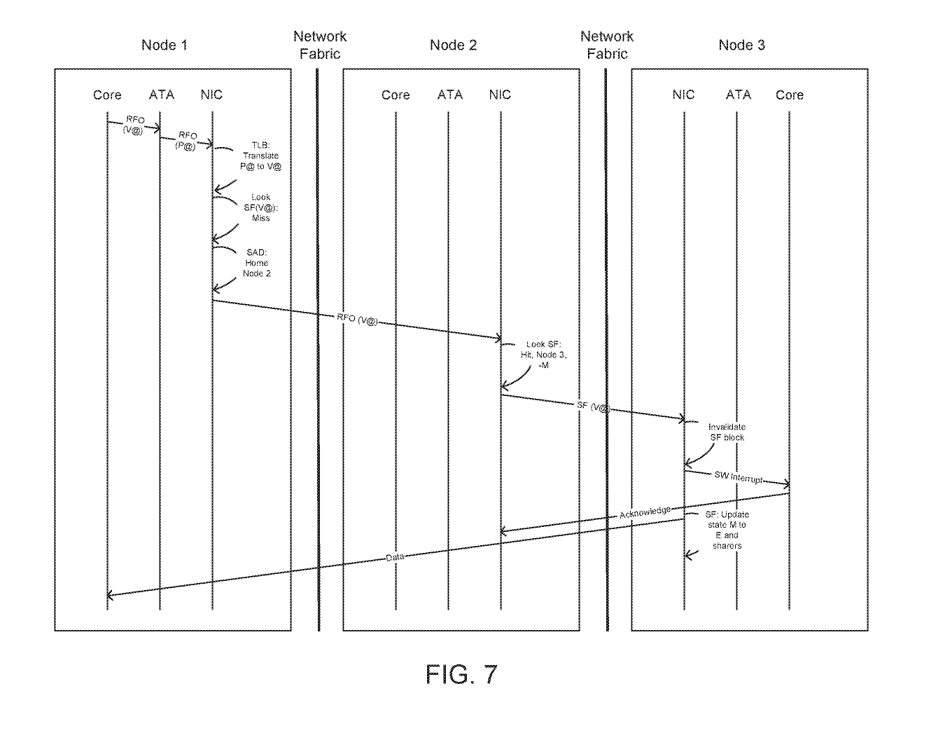

FIGS. 7-10 show various example coherency protocol flows to demonstrate a sampling of possible implementations. It is noted that not all existing flow possibilities are shown; however, since the protocol flows shown in these figures utilize similar transitions among permission states as a standard MESI protocol, it will be clear to one of ordinary skill in the art how the protocol could be implemented across all protocol flow possibilities. It should be understood that the implementation of the presently disclosed technology in a manner similar to MESI is non-limiting, and any compatible permission state protocol is considered to be within the present scope.

FIG. 7 shows a nonlimiting example flow of a Read for Ownership (RFO) for a shared I/O block from a requesting node (Node 1) to other nodes in the network that have rights to share that I/O block. The RFO message results in the snooping of all the sharers of the I/O block in order to invalidate their copies of the I/O block, and the Node or Node process requesting the RFO will now have exclusive rights to the I/O block, or in other words, an exclusive coherence state (E). In the example of FIG. 7, a core in Node 1 requests an RFO, the ATA identifies that the address associated with the RFO address is part of the shared address space, and forwards the RFO to the NIC. If the RFO address is a physical address (P@), the NIC translates the physical address to the associated virtual address (V@) in the shared address space. The NIC then performs a lookup of the virtual address in the NIC's SF. If the NIC lookup results in a miss, Node 1 identifies the home node for the I/O block using a SAD, which in this example is Node 2. The NIC then forwards the RFO to Node 2, and Node 2 performs a SF lookup, where in this case the I/O block has a permission state set to modified (M) by Node 3. Node 2 snoops the I/O block in Node 3, which causes Node 3 to invalidate the copy of the I/O block and to send a software (SW) interrupt to a core of Node 3. The SW interrupt causes a flush of any data related to the I/O block, with which the I/O block is then updated. Once the I/O block has been updated with any data modifications, then Node 3's NIC sends the I/O block (Data in FIG. 7) to the NIC of Node 1, thus fulfilling the RFO.

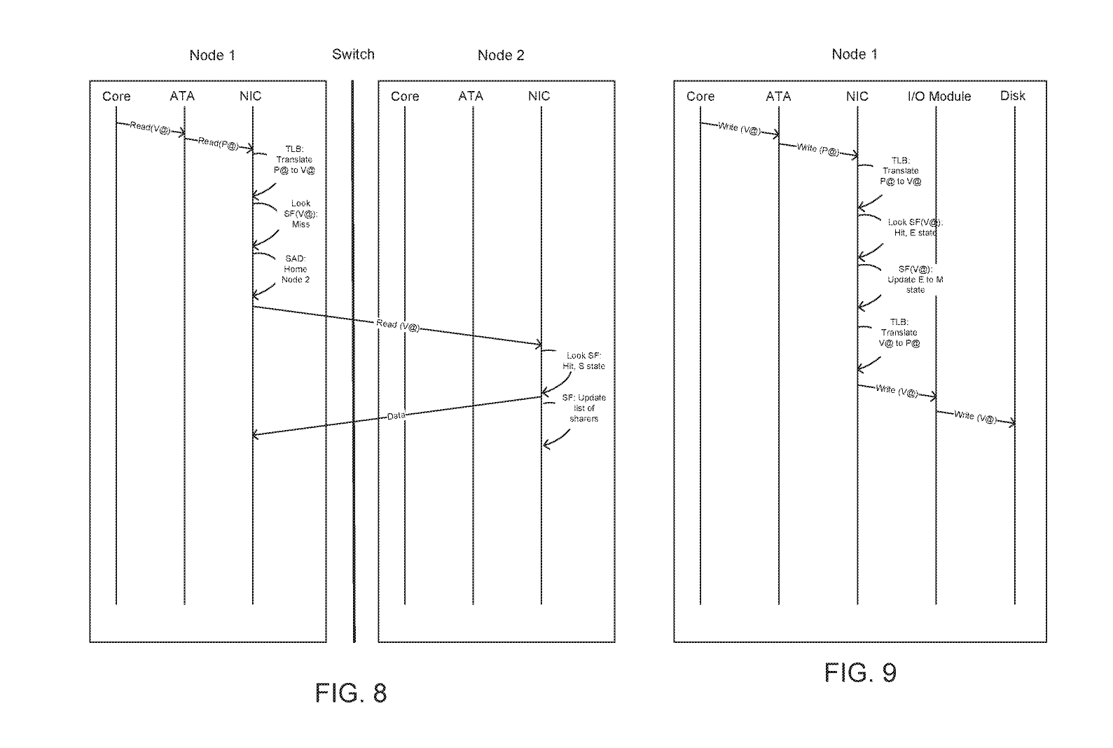

FIG. 8 shows a nonlimiting example flow of a read miss at Node 1 for an I/O block set to a shared permission state and owned by Node 2. In this case, a core in Node 1 requests a read access, and the ATA of Node 1 identifies that the read access address is part of the shared address space, and forwards the request for read access to the NIC of Node 1. If the read access address is a physical address (P@), the NIC translates the physical address to the associated virtual address (V@) in the shared address space. The NIC then performs a lookup of the virtual address in the NIC's SF. If the NIC lookup determines that the I/O block is set to invalid (I) (i.e., a miss), Node 1 identifies the home node for the I/O block using a System Address Decoder (SAD), which in this example is Node 2. The NIC then forwards the request to Node 2, and the NIC of Node 2 performs a SF lookup to determine that the I/O block has a coherence state set to shared (S) (i.e., a hit). A shared coherence state, along with a read request, does not need any further snoop inquiries, because the shared coherence state indicates that all nodes having sharing rights to the I/O block only have read access permission. The requesting node is asking for read access as well, and as such, a coherency issue will not arise from multiple nodes reading the same I/O block. In such cases, Node 2 could send snoop inquiries to the sharing nodes, but such inquiries would only return what is already specified by the shared coherence state of the I/O block, and as such, are not necessary. In this case, the NIC of Node 2 sends a copy of the requested I/O block (Data in FIG. 8) directly to the NIC of Node 1 to fulfill the read access request. The NIC of Node 2 updates the list of nodes sharing (sharers) the I/O block to include Node 1.

FIG. 9 shows a non-limiting example of a write access to the shared address space for an I/O block in which the requesting node is the owner and the I/O block is set to a permission state of exclusive. In this case, a core of Node 1 requests write access, and the ATA of Node 1 identifies that the write access address is part of the shared address space. The ATA then forwards the write access to the NIC of Node 1. If the write access is a physical address (P@), the NIC translates the physical address to the associated virtual address (V@) in the shared address space. The NIC then performs a lookup of the virtual address in the NIC's SF, and determines that the I/O block is set to a permission state of exclusive (E) (i.e., a hit). Because the I/O block is set to an exclusive permission state, a further snoop to any other node is not needed. The NIC updates the permission state of the I/O block from exclusive to modified (M), translates the virtual address to the associated physical address, and forwards the write access to the I/O module of Node 1.

Situations can arise where two nodes request ownership of the same shared I/O block at the same time. In such cases, a home node will grant the ownership of the I/O block to a requestor node in a prioritized fashion, such as, for example, the first RFO received. If a second RFO from a second requestor node is received while the first RFO is being processed, the home node sends a negative-acknowledgment (NAck) to the second requestor node, along with a snoop to invalidate the block. The NAck causes the second requestor node to wait for an amount of time to allow the first RFO to finish processing, after which the second requestor node can resubmit an RFO. It is noted that, in some cases, the prioritization of RFOs may be overridden by other policies, such as conflict handling.

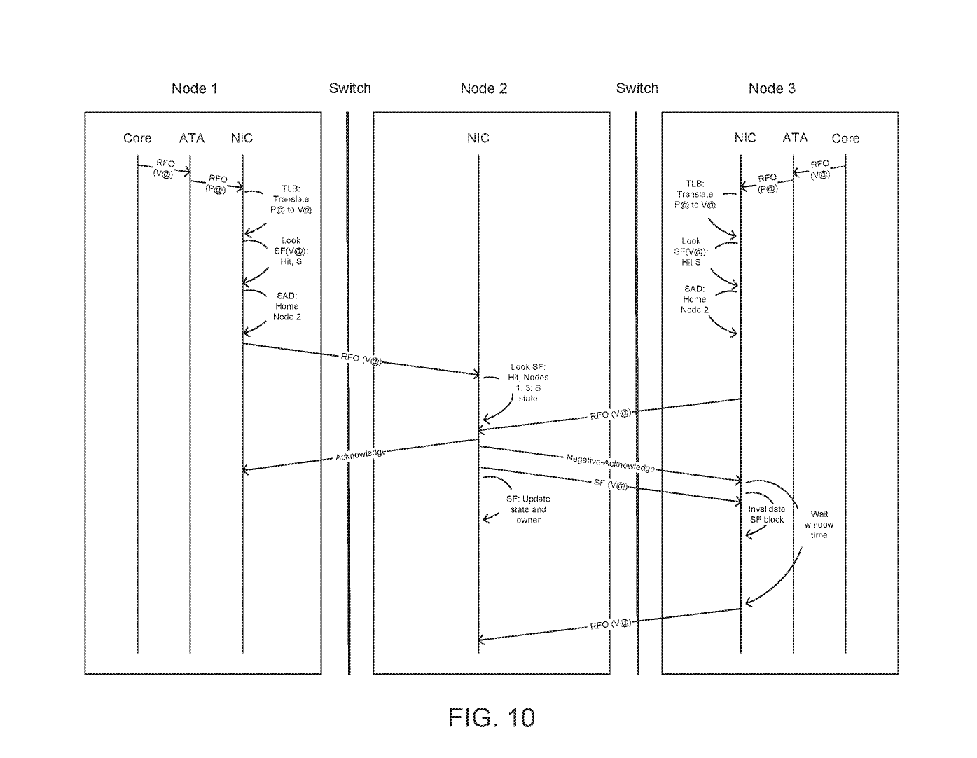

FIG. 10 shows a nonlimiting example of the prioritization of RFOs from two nodes requesting ownership of the same shared I/O block at the same time. A core in Node 1 requests an RFO, the ATA identifies that the address associated with the RFO address is part of the shared address space, and forwards the RFO to the Node 1 NIC. If the RFO address is a physical address (P@), the NIC translates the physical address to the associated virtual address (V@) in the shared address space. The NIC then performs a lookup of the virtual address in the NIC's SF. If the NIC lookup results in a miss, Node 1 identifies the home node for the I/O block using a System Address Decoder (SAD), which in this example is Node 2. The NIC then forwards the RFO to Node 2, and Node 2 performs a SF lookup, where in this case the I/O block has a permission state set to shared (S) by Nodes 1 and 3. In the meantime, Node 2 has received an RFO from Node 3 for the same shared I/O block. As a result, Node 2 sends an acknowledgment (Ack) to Node 1 for ownership and a NAck to Node 3 to wait for a time to allow the Node 1 RFO to finish processing, along with a snoop to invalidate the I/O block. Node 3 invalidates the I/O block in Node 3's SF, waits for a specified amount of time, and resends the RFO to Node 2. If the RFO is requested again while the previous RFO flow has not finished, a new NAck will be sent to Node 3. This prioritization is a relaxation of memory consistency; however, coherency is not broken because this is implemented when there is a transition from an S state to an E state, where the I/O block has not been modified. Such prioritization of incoming RFOs avoids potential livelocks, where ownership of the I/O block is changing back and forth between Node 1 and Node 3, and neither node is able to start writing.

In some examples, scale-up and scale-out system architectures include a fault recovery mechanism, since they can be prone to experience node failures as a given system grows. A coherency protocols also take into account also how to respond when a node crashes in order to avoid inconsistent permission states and unpredictable behavior. In one non-limiting example, a node that has stopped responding is a home node for shared I/O blocks. When a node fails, all of the shared space that was being tracked by that node becomes untracked. This leads not only to an inconsistent state, but to a state where such address space is inaccessible because the home node cannot respond to the requests of other nodes, which need to wait for the data. One nonlimiting example of a recovery mechanism utilizes a hybrid solution of hardware and software. In such cases, the first node to discover that the home node is dead triggers a software interrupt to itself, and gives the control to the software stack. The software stack will rearrange the shared address space such that all of the I/O blocks are properly tracked again. This solution relies on replication mechanisms having been implemented to maintain several copies of each block, that can be accessed and sent to their new home node. It is noted that all of the coherency structures, such as the SF table, need to be replicated along with the blocks. In one example of a further optimization, a replication mechanism can replicate the blocks in potential new home nodes for those blocks before the loss of the current home node. Therefore, the recovery mechanism is simplified by merely having to notify a new home node that it will now be tracking the I/O blocks that it is already hosting.

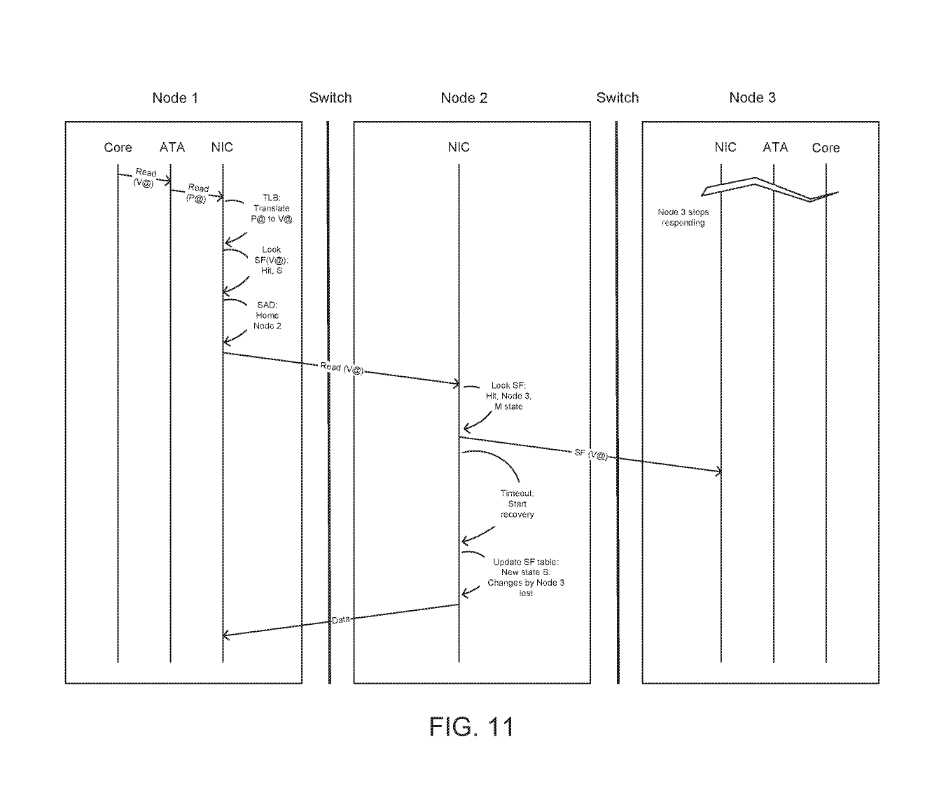

In another non-limiting example, a node that is not responding holds a modified version of an I/O block, where the home node of the I/O block is in a different and responsive node. FIG. 11 shows such an example, where Node 1 is the requestor node, Node 2 is the home node, and Node 3 is the unresponsive node. It is noted that only the NIC is shown in Node 2 for clarity. A core in Node 1 sends a read access to the ATA, which identifies that the address associated with the read access is part of the shared address space, and forwards the read access to the Node 1 NIC. If the read access address is a physical address (P@), the NIC translates the physical address to the associated virtual address (V@) in the shared address space. The NIC then performs a lookup of the virtual address in the NIC's SF. In this case the NIC lookup results in a hit, with the I/O block being in a shared (S) state. Node 1 identifies the home node for the I/O block using a System Address Decoder (SAD), and then forwards the read access to Node 2. Node 2 performs a SF lookup, where in this case the I/O block has a permission state set to shared (S) by Node 3. Node 2 then snoops the I/O block in Node 3 in order to invalidate the block, but receives no response because Node 3 is not responding. Following a timeout period, Node 2 implements a fault recovery mechanism by updating the state of the I/O block to shared (S) in Node 2's SF table and sending the latest version of the I/O block (Data) to Node 1. While the modifications to the I/O block by Node 3 have been lost, the recovery mechanism implemented by Node 2 has returned the memory of the system to a coherent state.

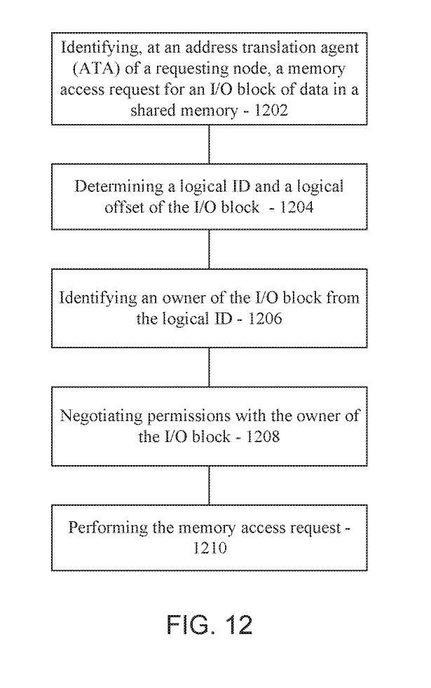

FIG. 12 illustrates an example method of sharing data while maintaining data coherence across a multi-node network. Such a method can include 1202 identifying, at a ATA of a requesting node, a memory access request for an I/O block of data in a shared memory, 1204 determining a logical ID and a logical offset of the I/O block, 1206 identifying an owner of the I/O block from the logical ID, 1208 negotiating permissions with the owner of the I/O block, and 1210 performing the memory access request.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific embodiments and point out specific features, elements, or steps that can be used or otherwise combined in achieving such embodiments.

In one example there is provided an apparatus comprising circuitry configured to identify a memory access request from a requesting node for an I/O block of data in a shared I/O address space of a multi-node network, determine a logical ID and a logical offset of the I/O block, identify an owner of the I/O block, negotiate permissions with owner of the I/O block, and perform the memory access request on the I/O block.

In one example of an apparatus, the owner is a home node for the I/O block coupled to the requesting node through a network fabric of the multi-node network.

In one example of an apparatus, the memory access request is a Read for Ownership (RFO) and, in negotiating permissions, the circuitry is further configured to set a coherency state of the I/O block to “exclusive,” and send the I/O block to the requesting node.

In one example of an apparatus, in setting the coherency state of the I/O block to “exclusive,” the circuitry is further configured to identify a sharing node of the I/O block, set the coherency state of the I/O block to “invalid” at the sharing node, and wait for an acknowledgment from the sharing node before the I/O block is sent to the requesting node.

In one example of an apparatus, in setting the coherency state of the I/O block to “exclusive,” the circuitry is further configured to identify that the coherency state of the I/O block at the sharing node is set to “modified,” initiate a software interrupt by the sharing node, flush data related to the I/O block from processes at the sharing node to the I/O block, now a modified I/O block, and send the modified I/O block to the requesting node as the I/O block.

In one example of an apparatus, the memory access request is a read access request and, in negotiating permissions, the circuitry is further configured to determine that the I/O block has a coherency state set to “shared” at the home node, send a copy of the I/O block to the requesting node, and add the requesting node to a list of sharers at the home node.

In one example of an apparatus, the owner is the requesting node.

In one example of an apparatus, the memory access request is a Read for Ownership (RFO) and, in negotiating permissions, the circuitry is further configured to set a coherency state of the I/O block to “modified,” and write the I/O block to the shared I/O space.

In one example of an apparatus, in setting the coherency state of the I/O block to “modified,” the circuitry is further configured to identify a sharing node of the I/O block, set the coherency state of the I/O block to “invalid” at the sharing node, and wait for an acknowledgment from the sharing node before writing the I/O block to the shared I/O space.

In one example of an apparatus, in setting the coherency state of the I/O block to “modified”, the circuitry is further configured to identify that the coherency state of the I/O block at the sharing node is set to “modified,” initiate a software interrupt by the sharing node, flush data related to the I/O block from processes at the sharing node to the I/O block, now a modified I/O block, and send the modified I/O block to the requesting node as the I/O block.

In one example of an apparatus, in determining the logical ID and the logical offset of the I/O block, the circuitry is further configured to identify a physical address for the I/O block at the requesting node, and mapping the physical address to the logical ID and logical I/O offset.

In one example there is provided a multi-node system having coherent shared data, comprising a plurality of computing nodes, each comprising one or more processors, an address translation agent (ATA), and a network interface controller (NIC), each NIC comprising a snoop filter (SF) including a coherence logic (CL) and a translation lookaside buffer (TLB). Additionally, a network fabric is coupled to each computing node through each NIC, a shared memory is coupled to each computing node, wherein each computing node has ownership of a portion of the shared memory address space, and the system further comprises circuitry configured to identify, at the ATA of a requesting node, a memory access request for an I/O block of data in a shared memory, determine a logical ID and a logical offset of the I/O block, identify an owner of the I/O block from the logical ID, negotiate permissions with owner of the I/O block, and perform the memory access request on the I/O block.

In one example of a system, the owner is a home node for the I/O block coupled to the requesting node through the network fabric of the multi-node system.

In one example of a system, the memory access request is a Read for Ownership (RFO) and, in negotiating permissions, the circuitry is further configured to set a coherency state of the I/O block to “exclusive” at the SF of the home node and send the I/O block to the requesting node through the network fabric.

In one example of a system, in setting the coherency state of the I/O block to “exclusive,” the circuitry is further configured to identify a sharing node of the I/O block using the SF of the requesting node, set the coherency state of the I/O block to “invalid” at the SF of the sharing node, and wait for an acknowledgment from the NIC of the sharing node before the I/O block is sent to the requesting node.

In one example of a system, in setting the coherency state of the I/O block to “exclusive,” the circuitry is further configured to identify that the coherency state of the I/O block at the sharing node is set to “modified” using the SF of the requesting node, initiate a software interrupt at the sharing node, flush data related to the I/O block from processes at the sharing node to the I/O block, now a modified I/O block, and send the modified I/O block to the requesting node as the I/O block.

In one example of a system, the memory access request is a read access request and, in negotiating permissions, the circuitry is further configured to determine that the I/O block has a coherency state set to “shared” at the home node using the SF of the requesting node, send a copy of the I/O block to the requesting node, and add the requesting node to a list of sharers in the SF of the home node.

In one example of a system, the owner is the requesting node.

In one example of a system, the memory access request is a Read for Ownership (RFO) and, in negotiating permissions, the circuitry is further configured to set a coherency state of the I/O block to “modified” at the SF of the requesting node and write the I/O block to the shared I/O space using an I/O module of the requesting node.

In one example of a system, in setting the coherency state of the I/O block to “modified,” the circuitry is further configured to identify a sharing node of the I/O block using the SF of the requesting node, set the coherency state of the I/O block to “invalid” at the SF of the sharing node, and wait for an acknowledgment from the NIC of the sharing node before writing the I/O block to the shared I/O space.

In one example of a system, in setting the coherency state of the I/O block to “modified,” the circuitry is further configured to identify that the coherency state of the I/O block at the sharing node is set to “modified” using the SF of the requesting node, initiate a software interrupt at the sharing node. flush data related to the I/O block from processes at the sharing node to the I/O block, now a modified I/O block, and send the modified I/O block to the requesting node as the I/O block.

In one example of a system, in determining the logical ID and the logical offset of the I/O block, the circuitry is further configured to identify a physical address for the I/O block at the ATA of the requesting node, send the physical address to the TLB of the requesting node, and map the physical address to the logical ID and logical I/O offset using the TLB.

In one example of a system, in determining the logical ID and the logical offset of the I/O block, the circuitry is further configured to receive, at the HLF of the requesting node, the logical ID and the logical offset of the I/O block.

In one example of a system, the owner is a home node of the I/O block, and the circuitry is further configured to send the logical ID to the SF, perform a system address decoder (SAD) lookup of the logical ID, and identify the home node from the SAD lookup.

In one example there is provided a method of sharing data while maintaining data coherence across a multi-node network, comprising identifying, at an address translation agent (ATA) of a requesting node, a memory access request for an I/O block of data in a shared memory, determining a logical ID and a logical offset of the I/O block, identifying an owner of the I/O block from the logical ID, negotiating permissions with the owner of the I/O block, and performing the memory access request.

In one example of a method, the owner is a home node for the I/O block coupled to the requesting node through a network fabric of the multi-node network.

In one example of a method, the memory access request is a Read for Ownership (RFO) and, in negotiating permissions, the method further comprises setting a coherency state of the I/O block to “exclusive” at a snoop filter (SF) of the home node, and sending the I/O block to the requesting node through the network fabric.

In one example of a method, in setting the coherency state of the I/O block to “exclusive,” the method further comprises identifying a sharing node of the I/O block using the SF of the requesting node, setting the coherency state of the I/O block to “invalid” at a SF of the sharing node, and waiting for an acknowledgment from a network interface controller (NIC) of the sharing node before the I/O block is sent to the requesting node.

In one example of a method, in setting the coherency state of the I/O block to “exclusive”, the method further comprises identifying that the coherency state of the I/O block at the sharing node is set to “modified” using the SF of the requesting node, initiating a software interrupt at the sharing node, flushing data related to the I/O block from processes at the sharing node to the I/O block, now a modified I/O block, and sending the modified I/O block to the requesting node as the I/O block.

In one example of a method, the memory access request is a read access request and, in negotiating permissions, the method further comprises determining that the I/O block has a coherency state set to “shared” at the home node using a snoop filter (SF) of the requesting node, sending a copy of the I/O block to the requesting node, and adding the requesting node to a list of sharers in the SF of the home node.

In one example of a method, the owner is the requesting node.

In one example of a method, the memory access request is a Read for Ownership (RFO) and, in negotiating permissions, the method further comprises setting a coherency state of the I/O block to “modified” at a snoop filter (SF) of the requesting node, and writing the I/O block to the shared I/O space using an I/O module of the requesting node.

In one example of a method, in setting the coherency state of the I/O block to “modified,” the method further comprises identifying a sharing node of the I/O block using the SF of the requesting node, setting the coherency state of the I/O block to “invalid” at a SF of the sharing node, and waiting for an acknowledgment from a network interface controller (NIC) of the sharing node before writing the I/O block to the shared I/O space.

In one example of a method, in setting the coherency state of the I/O block to “modified,” the method further comprises identifying that the coherency state of the I/O block at the sharing node is set to “modified” using the SF of the requesting node, initiating a software interrupt at the sharing node, flushing data related to the I/O block from processes at the sharing node to the I/O block, now a modified I/O block, and sending the modified I/O block to the requesting node as the I/O block.

In one example of a method, in determining the logical ID and the logical offset of the I/O block, the method further comprises identifying a physical address for the I/O block at the ATA of the requesting node, sending the physical address to a translation lookaside buffer (TLB) of the requesting node, and mapping the physical address to the logical ID and logical I/O offset using the TLB.

In one example of a method, in determining the logical ID and the logical offset of the I/O block, the method further comprises receiving, at the HLF of the requesting node, the logical ID and the logical offset of the I/O block.

In one example of a method, the owner is a home node of the I/O block, and the to method further comprises sending the logical ID to a snoop filter (SF) of the requesting node, performing a system address decoder (SAD) lookup of the logical ID, and identifying the home node from the SAD lookup.

What is claimed is:

1. An apparatus comprising circuitry configured to:
identify a memory access request from a requesting node for an I/O block of data in a shared I/O address space of a multi-node network;
determine a logical identifier (ID) and a logical offset of the I/O block;
identify an owner of the I/O block;
negotiate permissions with owner of the I/O block; and
perform the memory access request on the I/O block.

2. The apparatus of claim 1, wherein the owner is a home node for the I/O block coupled to the requesting node through a network fabric of the multi-node network.

3. The apparatus of claim 2, wherein the memory access request is a Read for Ownership (RFO) and, in negotiating permissions, the circuitry is further configured to:
set a coherency state of the I/O block to “exclusive”; and
send the I/O block to the requesting node.

4. The apparatus of claim 3, wherein, in setting the coherency state of the I/O block to “exclusive,” the circuitry is further configured to:
identify a sharing node of the I/O block;
set the coherency state of the I/O block to “invalid” at the sharing node; and
wait for an acknowledgment from the sharing node before the I/O block is sent to the requesting node.

5. The apparatus of claim 4, wherein, in setting the coherency state of the I/O block to “exclusive”, the circuitry is further configured to:
identify that the coherency state of the I/O block at the sharing node is set to “modified”;
initiate a software interrupt by the sharing node;
flush data related to the I/O block from processes at the sharing node to the I/O block, now a modified I/O block; and
send the modified I/O block to the requesting node as the I/O block.

6. The apparatus of claim 2, wherein the memory access request is a read access request and, in negotiating permissions, the circuitry is further configured to:
determine that the I/O block has a coherency state set to “shared” at the home node;
send a copy of the I/O block to the requesting node; and
add the requesting node to a list of sharers at the home node.

7. The apparatus of claim 1, wherein the owner is the requesting node.

8. The apparatus of claim 7, wherein the memory access request is a Read for Ownership (RFO) and, in negotiating permissions, the circuitry is further configured to:
set a coherency state of the I/O block to “modified”; and
write the I/O block to the shared I/O space.

9. The apparatus of claim 8, wherein, in setting the coherency state of the I/O block to “modified,” the circuitry is further configured to:
identify a sharing node of the I/O block;
set the coherency state of the I/O block to “invalid” at the sharing node; and
wait for an acknowledgment from the sharing node before writing the I/O block to the shared I/O space.

10. The apparatus of claim 9, wherein, in setting the coherency state of the I/O block to “modified”, the circuitry is further configured to:
identify that the coherency state of the I/O block at the sharing node is set to “modified”;
initiate a software interrupt by the sharing node;
flush data related to the I/O block from processes at the sharing node to the I/O block, now a modified I/O block; and
send the modified I/O block to the requesting node as the I/O block.

11. The apparatus of claim 1, wherein, in determining the logical ID and the logical offset of the I/O block, the circuitry is further configured to:
identify a physical address for the I/O block at the requesting node; and
mapping the physical address to the logical ID and logical I/O offset.

12. A multi-node system having coherent shared data, comprising:
a plurality of computing nodes, each comprising:
one or more processors;
an address translation agent (ATA); and
a network interface controller (NIC), each NIC comprising:
a snoop filter (SF) including a coherence logic (CL); and
a translation lookaside buffer (TLB);
a network fabric coupled to each computing node through each NIC;
a shared memory coupled to each computing node, wherein each computing node has ownership of a portion of the shared memory address space; and
circuitry configured to:
identify, at the ATA of a requesting node, a memory access request for an I/O block of data in a shared memory;
determine a logical ID and a logical offset of the I/O block;
identify an owner of the I/O block from the logical ID;
negotiate permissions with owner of the I/O block; and
perform the memory access request on the I/O block.

13. The system of claim 12, wherein the owner is a home node for the I/O block coupled to the requesting node through the network fabric of the multi-node system.

14. The system of claim 13, wherein the memory access request is a Read for Ownership (RFO) and, in negotiating permissions, the circuitry is further configured to:
set a coherency state of the I/O block to “exclusive” at the SF of the home node; and
send the I/O block to the requesting node through the network fabric.

15. The system of claim 14, wherein, in setting the coherency state of the I/O block to “exclusive,” the circuitry is further configured to:
identify a sharing node of the I/O block using the SF of the requesting node;
set the coherency state of the I/O block to “invalid” at the SF of the sharing node; and
wait for an acknowledgment from the NIC of the sharing node before the I/O block is sent to the requesting node.

16. The system of claim 15, wherein, in setting the coherency state of the I/O block to “exclusive”, the circuitry is further configured to:
identify that the coherency state of the I/O block at the sharing node is set to “modified” using the SF of the requesting node;
initiate a software interrupt at the sharing node;
flush data related to the I/O block from processes at the sharing node to the I/O block, now a modified I/O block; and
send the modified I/O block to the requesting node as the I/O block.

17. The system of claim 13, wherein the memory access request is a read access request and, in negotiating permissions, the circuitry is further configured to:
determine that the I/O block has a coherency state set to “shared” at the home node using the SF of the requesting node;
send a copy of the I/O block to the requesting node; and
add the requesting node to a list of sharers in the SF of the home node.

18. The system of claim 12, wherein the owner is the requesting node.

19. The system of claim 18, wherein the memory access request is a Read for Ownership (RFO) and, in negotiating permissions, the circuitry is further configured to:
set a coherency state of the I/O block to “modified” at the SF of the requesting node; and
write the I/O block to the shared I/O space using an I/O module of the requesting node.

20. The system of claim 19, wherein, in setting the coherency state of the I/O block to “modified,” the circuitry is further configured to:
identify a sharing node of the I/O block using the SF of the requesting node;
set the coherency state of the I/O block to “invalid” at the SF of the sharing node; and
wait for an acknowledgment from the NIC of the sharing node before writing the I/O block to the shared I/O space.

21. The system of claim 20, wherein, in setting the coherency state of the I/O block to “modified”, the circuitry is further configured to:
identify that the coherency state of the I/O block at the sharing node is set to “modified” using the SF of the requesting node;
initiate a software interrupt at the sharing node;
flush data related to the I/O block from processes at the sharing node to the I/O block, now a modified I/O block; and
send the modified I/O block to the requesting node as the I/O block.

22. The system of claim 12, wherein, in determining the logical ID and the logical offset of the I/O block, the circuitry is further configured to:
identify a physical address for the I/O block at the ATA of the requesting node;
send the physical address to the TLB of the requesting node; and
map the physical address to the logical ID and logical I/O offset using the TLB.

23. The system of claim 12, wherein, in determining the logical ID and the logical offset of the I/O block, the circuitry is further configured to receive, at the HLF of the requesting node, the logical ID and the logical offset of the I/O block.

24. The system of claim 12, wherein the owner is a home node of the I/O block, and the circuitry is further configured to:
send the logical ID to the SF;
perform a system address decoder (SAD) lookup of the logical ID; and
identify the home node from the SAD lookup.
